(19) United States
(12) Patent Application Publication
(10) Pub. No.: US 2010/0264756 A1
(43) Pub. Date: Oct. 21, 2010

(54) Multiple-Degree Of Freedom System And Method Of Using Same

(75) Inventors: Kok-Meng Lee, Norcross, GA (US); Hungsun Son, Atlanta, GA (US); Jong Kweon Park, Daejeon (KR); Kun Bai, Atlanta, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Georgia Tech Research Corporation, Atlanta, GA (US)

(21) Appl. No.: 12/608,838

(22) Filed: Oct. 29, 2009

Related U.S. Application Data
(60) Provisional application No. 61/109,328, filed on Oct. 29, 2008.

(51) Int. Cl. H02K 33/00; H02K 7/09

(52) U.S. Cl. 310/38; 310/90.5

(57) ABSTRACT

A multi-DOF system including a bearing for centering a first body relative a second body, and a work piece surface tiltable via the first body, wherein the bearing comprises a magnetically levitated bearing.

### CROSS REFERENCE TO RELATED APPLICATION

This application claims benefit under 35 USC §119(e) of U.S. Provisional Patent Application Ser. No. 61/109,328 filed 29 Oct. 2008, which application is hereby incorporated fully by reference.

### BACKGROUND OF THE INVENTION

1. Field of the Invention

The present invention relates generally to multiple-degree of freedom (multi-DOF) systems, and more specifically to a multi-DOF spherical actuator for meso-scale machine tool applications where multi-DOF tiltable positioning stages and high-speed spindles are important aspects.

2. Description of the Related Art

Growing demands for miniature devices in modern industries (such as micro-machining and bio-manufacturing), along with the trend to downscale equipment for manufacturing these products on “desktops”, have motivated the development of actuators for high-speed spindles and high-accuracy stages capable of precision orientation control of the cutter and work-piece for machining applications.

Existing multi-DOF stage designs typically use a combination of single-axis actuators to control orientation. Driven by the stringent accuracy and tolerance requirements, various forms of micro-motion parallel mechanisms with three or more single-axis actuators have been proposed. Such multi-DOF mechanisms are generally bulky, and lack of dexterity in negotiating the orientation of the cutter or work-piece. Ball-joint-like actuators (capable of three-DOF dexterous orientation in a single joint) offer an attractive solution to eliminate motion singularities of a multi-DOF tiltable stage.

Several spherical motor designs have been proposed in the last two decades, which include a spherical induction motor, variable-reluctance spherical motors (VRSMs), and an ultrasonic motor. For reasons including compact design, VRSMs have received more research attention than their counterparts. Past research efforts, however, have largely focused on dynamic modeling and control of the VRSM.

Variable reluctance spherical motor research has been motivated by the role of dexterous actuators and sensors for measurement and control of high precision dynamic systems and manufacturing automation. The present inventors have designed a three-DOF ball-joint-like variable-reluctance spherical motor, and a means to provide non-contact direct sensing of roll, yaw, and pitch motion in a single joint has been investigated. From this work, a rational basis for design, modeling, and control of a three-DOF VR wrist motor has been developed.

More recently, the present inventors have investigated the feasibility of designing a spherical wheel motor (SWM) for applications (such as car wheels, propellers for boats, helicopter or underwater vehicle, gyroscopes, and machine tools) where dexterous orientation control of a continuously rotating shaft is needed. Unlike a VRSM where the stator permanent magnets (PM) and the rotor electromagnets (EM) are placed on locations following the vertices of a regular polygon, equally-spaced magnetic poles are placed on layers of circular planes for a SWM. This enables the shaft to spin using a switching controller while allowing the shaft to incline much like a VRSM.

It can be seen that there is a need for an actuator and a multi-DOF tiltable stage using such an actuator, that offers a relatively large range of singularity-free motion. While high-accuracy stages capable of precision orientation control are known, the advancement of science demands better accuracy and control, not found in conventional systems. What is needed, therefore, is an actuator and a multi-DOF tiltable stage that allows for contact-free manipulation, wherein the rotor is magnetically levitated (maglev). It is to the provision of such systems that the present invention is primarily directed.

### BRIEF SUMMARY OF THE INVENTION

The present invention is a multi-DOF system including a bearing for centering a first body relative a second body, and a work piece surface tiltable via the first body, wherein the bearing comprises a magnetically levitated bearing. In an exemplary embodiment, the multi-DOF system uses high-coercive permanent magnets (PM) to levitate a tiltable stage for desktop machining applications. The PM-based magnetically levitated bearing for the tiltable stage inherits the isotropic motion properties of a ball-joint, while the stage is allowed for contact-free manipulation.

The first body of the present invention can comprises a rotor, and more preferably a spherical rotor having a plurality of rotor magnetic field generators. The second body of the present invention can comprises a stator, and more preferably a spherical stator having a plurality of stator magnetic field generators.

Unlike conventional designs where orientation must be controlled using closed-loop feedback, the present invention can be controlled in an open-loop without external sensors by decoupling the shaft inclination control from the spin rate regulation.

In an exemplary embodiment, the present invention is a three-DOF circular stage with precision of 0.1-0.5 μm and less than 0.1 mm runout, with a tiltable range of ±22.5°, and a maximum load handling of 100N load (with stage) and 10N cutting force.

The present invention provides a compact design with minimum coupling between the maglev and the orientation control. The present spherical wheel motor can comprise a spherical stator having a plurality of stator magnetic field generators, preferably electromagnets. A spherical rotor having a plurality of rotor magnetic field generators, preferably permanent magnets, is freely movable within the stator via magnetic levitation. An assembly of high-coercive permanent magnets is designed to levitate the ball-joint-like stage. The rotor has a center of rotation, and the plurality of preferable permanent magnets can comprise a primary rotor permanent magnet, and one or more rings of permanent magnets with their axis pointing towards the center of rotation. The spherical rotor is concentric with the stator and has an infinite number of rotational axes about its center with three-DOF. A motor shaft is mounted to the rotor and protrudes outwardly through a circular stator opening, which permits isotropic movement of a distal end of the motor shaft. Alternatively, a table (on which the work piece is placed) can be mounted on the rotor.

The present invention further provides a method for design and control of a PM-based magnetically levitated bearing for a multi-DOF tiltable stage. Force prediction for a cost-effective maglev design requires a good understanding of the magnetic fields and forces involved. Existing techniques for analyzing electromagnetic fields of a multi-DOF actuator rely primarily on three approaches; namely, analytic solutions to Laplace equation, numerical methods and lumped-parameter analyses with some forms of equivalent circuits. Yet, these approaches have difficulties in achieving both accuracy and low computation time simultaneously.

The present invention provides two exemplary methods, referred herein as distributed multi-pole (DMP) and equivalent single layer (ESL) modeling methods, for computing the magnetic fields of a permanent magnet (PM) and a multi-layer electromagnet (EM). An efficient method based on the DMP modeling for computing the three-dimensional (3D) magnetic fields, forces, and torques is disclosed. The DMP model offers the field solution in closed form, upon which magnetic forces and torques can then be computed from the surface integration in terms of a Maxwell stress tensor. The application of the DMP method for the design of a maglev for the multi-DOF tiltable stage is shown.

The effects of key design parameters on the maglev performance are investigated by comparing two characteristic design configurations. A first design uses a single pair of permanent magnets to regulate the z motion of the rotor, leaving the remaining DOF to the control of the spherical motor being levitated. Unlike the first design that is inherently open-loop unstable, a second design uses multiple magnets to design a neutrally open-loop stable system for a zero-damping maglev. These two maglev design configurations are simulated and compared in the application of a spherical wheel motor.

### BRIEF DESCRIPTION OF THE FIGURES

FIG. 1 illustrates a preferred embodiment of the present invention as a multi-DOF micro machine.

FIGS. 2a-2b illustrate a perspective view of the rotor and stator, respectively, according to a preferred embodiment of the present invention.

FIG. 3 illustrates a cross-sectional view of the magnetic actuation of a preferred embodiment of the present invention, as a magnetically levitated tiltable stage for a micro-machine.

FIG. 4 illustrates schematics for torque computation of a preferred embodiment of the present invention.

FIGS. 5a-5b illustrate the method of finding an equivalent single layer model for an axi-symmetrical multilayer coil with a current density J, wherein FIG. 5a is a cross-sectional view of a multilayer EM coil, and FIG. 5b illustrates the magnetic flux on the wire.

FIG. 6 illustrate the distributed multiple poles model a cylindrical magnet.

FIG. 7 shows Design A and Design B, being two design configurations illustrating the use of one, and a plurality, of stator magnets to regulate z motion of the rotor magnet.

FIGS. 8a-8e are graphs of the characteristic forces and torque of Design A and Design B of FIG. 7.

FIGS. 9a-9f are graphs of the rise time in the y response and z-motion rise time for Design A and Design B of FIG. 7, wherein α=1.

FIGS. 10a-10f are graphs of the rise time in the y response and z-motion rise time for Design A and Design B of FIG. 7, wherein α=4.52.

### DETAILED DESCRIPTION OF PREFERRED EMBODIMENTS

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

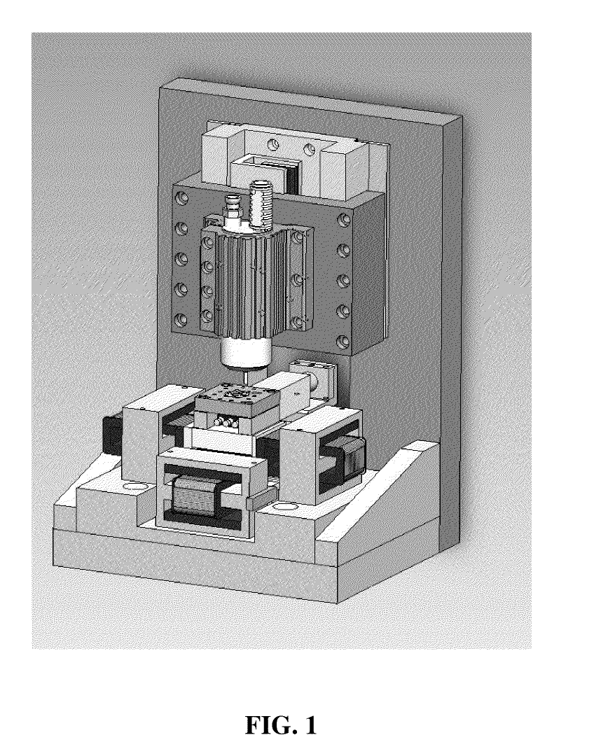

In a exemplary embodiment of the present invention, as shown in FIG. 1, a six-DOF machine 10 comprises three main components; a high-speed spindle 12 on a z-translational stage 14, an x-y translational stage 16, and a three-axis rotational stage 100 on which a table T is mounted.

The operational principle of the multi-DOF tiltable stage, which offers a relatively large range of singularity-free motion, and yet allows for contact-free manipulation, is similar to that of a spherical motor except that the rotor is magnetically levitated. The present invention comprises a maglev design to support the multi-DOF tiltable stage against gravity.

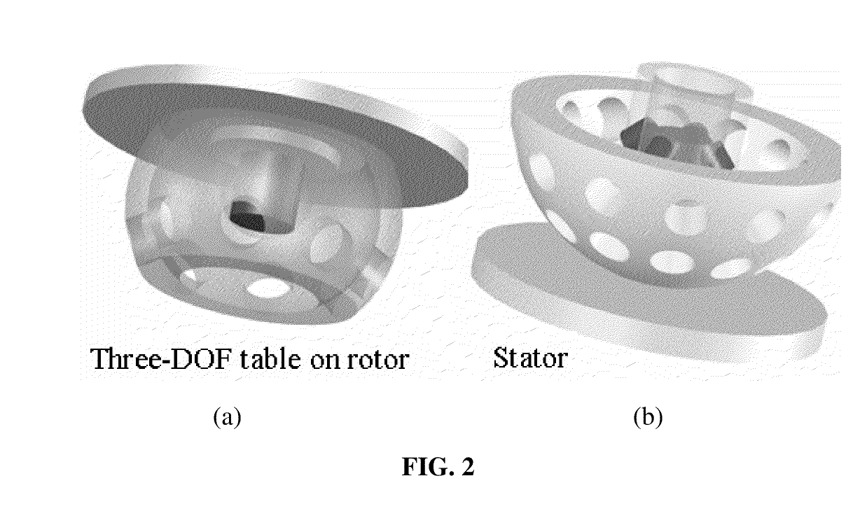

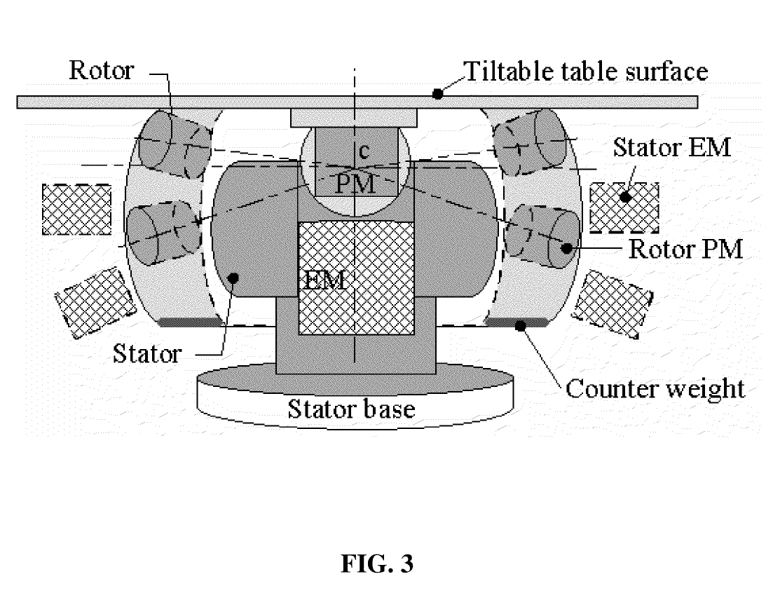

Electromechanically, the present invention is a compact design with minimum coupling between the maglev and the orientation control. FIGS. 2a-2b illustrate a perspective view of the rotor and stator, respectively, of the present invention. A cross-sectional view of a tiltable stage 100 as shown in FIG. 3 illustrates this design concept. In FIG. 3, the table T (on which a work piece is placed) is mounted on a rotor 110 comprising a primary PM 112 (embedded in a sphere 114 centered at c) and one or more rings of permanent magnets 116 (where i=1, 2, . . . , nᵣ) with their axis pointing towards the rotation center c. The actuators for the maglev and the orientation control of the SWM are a primary EM 118 mounted directly below the sphere 114, and two or more pairs of EM assemblies 120, respectively.

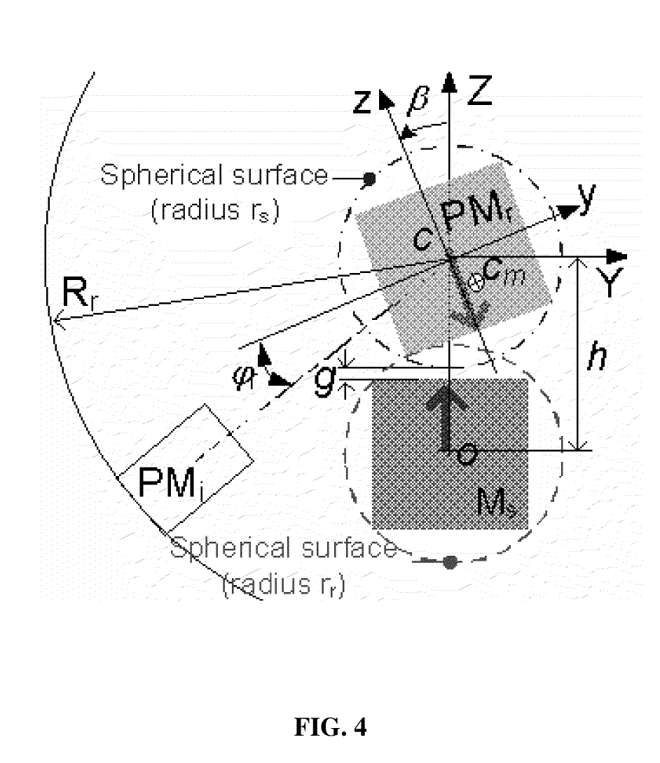

FIG. 4 illustrates the schematics for analyzing the maglev. The sphere (with the coordinate frame xyz) containing the permanent magnet PMᵣ is free to rotate about the rotor center c, and translate within the small air gap g with respect to the stator reference frame XYZ where the +X axis points outward. In FIG. 4, Mₛ is a fixed stator pole that may be an EM or a PM. The heavy arrows denote the direction of the magnets. For stability, the mass center cₘ of the rotational stage is designed such that it is below the rotation center c.

### Magnetic Forces and Torques

In static magnetic fields, the magnetic forces and torques can be computed using one of the two methods; Lorentz force equation or Maxwell stress tensor. The Lorentz force equation is commonly used to calculate the magnetic force exerted on current-carrying conductors, when active elements such as electromagnets (EM) are used. When magnetic forces are a result of passive interaction between permanent magnets, the Maxwell stress tensor Γ can be used to calculate the total magnetic force acting on the closed surface:

$$F = • {\int }_{Ω} Γ d Ω where Γ = \frac{1}{{μ}_{0}} ( B ( B • n ) - \frac{1}{2} {B}^{2} n ) \qquad ( 1 )$$

where Ω is an arbitrary boundary enclosing the body of interest; n is the normal of the material interface; and B=|B|. Since (1) computes the force on the given field, B is the total field on the surface of integration. The magnetic forces on the rotor are formulated by using the Maxwell stress tensor so that both the passive and active magnetic forces due to PM and EM can be computed using the same method.

For a given total magnetic field, the force and torque between PMᵣ and Mₛ can be computed from the integral over the spherical surface enclosing Mₛ. In spherical coordinates (r, θ, φ), the field point on a unit sphere is given by

r=[cos θ sin φ sin θ sin φ cos φ]^{T} (2)

and the normal to the spherical surface is

n=[cos θ sin φ sin θ sin φ cos φ]^{T} (3)

The integrals (over a spherical surface) for computing the magnetic force and torque acting on Mₛ is given by

$$\begin{matrix}F = [ \begin{matrix}{F}_{X} & {F}_{Y} & {{F}_{Z} ]}^{T} = \frac{{r}_{s}^{2}}{{μ}_{0}} {\int }_{θ = 0}^{2 π} {\int }_{φ = 0}^{π} [ Π ] n sin φ d φ d θ\end{matrix} & ( 4 a ) \\ T = [ \begin{matrix}{T}_{X} \\ {T}_{Y} \\ {T}_{Z}\end{matrix} ] = \frac{{r}_{s}^{3}}{{μ}_{0}} {\int }_{θ = 0}^{2 π} {\int }_{φ = 0}^{π} r \times ( [ Π ] n ) sin φ d φ d θ \\ where & ( 4 b ) \\ [ Π ] = [ \begin{matrix}{B}_{X}^{2} - {B}^{2} / 2 & {B}_{X} {B}_{Y} & {B}_{X} {B}_{Z} \\ {B}_{Y} {B}_{X} & {B}_{Y}^{2} - {B}^{2} / 2 & {B}_{Y} {B}_{Z} \\ {B}_{Z} {B}_{X} & {B}_{Z} {B}_{Y} & {B}_{Z}^{2} - {B}^{2} / 2\end{matrix} ] and B = [ \begin{matrix}{B}_{X} \\ {B}_{Y} \\ {B}_{Z}\end{matrix} ] & ( 4 c )\end{matrix}$$

In (4a) and (4b), the unit radial vector r, and normal n are given by (2) and (3). Equations (4a) and (4b) compute the force and torque on Mₛ, which must be negated to obtain the force and torque acting on PMᵣ.

The solutions to the force and torque integrals (4a) and (4b) require solving the total magnetic field (4c), which includes both the fields of PM and EM. The magnetic field considered here is continuous and irrotational, and the medium is homogeneous. A scalar magnetic potential can be defined that satisfies the Laplace equation; the solution can be solved for a dipole.

The Laplace equation is linear (and thus the principle of superposition is applicable) and enables the characterization of the magnetic field of a PM by summing the field contribution of an appropriate distribution of dipoles. Two methods offer the magnetic field solutions in closed-form. A first method uses an assembly of distributed multiple poles (DMP) that takes into account the shape of the physical PM to model the PM. A second method replaces the multilayer (ML) coil with an equivalent single-layer (ESL) model that retains the shape of the original ML coil, but with only one layer of wires, which can then be treated as an equivalent PM.

The method for finding the DMP model for a PM or a multi-layer EM have been validated against published experimental and numerical data. Once the DMP model of a PM or an EM are found, the magnetic fields can be computed using closed form equations.

### Dynamic Model

The rotor has six-DOF, q=[q_{T}(x, y, z) q_{R}(α, β, γ)]^{T}, where (x, y, z) are the coordinates of the rotor center c; and the ZYZ Euler angles (α, β, γ) characterize the orientation of the rotor. The rotor dynamics has the form:

$$[ \begin{matrix}{m}_{r} I & 0 \\ 0 & {M}_{R}\end{matrix} ] \ddot{q} + [ \begin{matrix}0 \\ {C}_{R} ( {q}_{R} , {\dot{q}}_{R} )\end{matrix} ] + [ \begin{matrix}{Q}_{T} \\ {Q}_{R}\end{matrix} ] = 0 \qquad ( 5 )$$

where m and M_{R} are the mass and the 3×3 inertia matrix of the rotor; C_{R}(q_{R},\dot{q}_{R}) is a 3×1 vector of centrifugal and Coriolis terms; and Q_{T} and Q_{R} are respectively the generalized force and torque (3×1) vectors which include the gravity terms.

Due to the structural symmetry and the small gap between the rotor and stator, the equations of motion can be simplified to three-DOF (y, z, β). In rotor frame,

$$\begin{matrix}{m}_{r} \ddot{y} = {f}_{y} - {m}_{r} g sin β + {Q}_{y} & ( 6 a ) \\ {m}_{r} \ddot{z} = {f}_{z} - {m}_{r} g cos β + {Q}_{z} & ( 6 b ) \\ {I}_{xx} \ddot{β} = {T}_{x} - {m}_{r} g ( {y}_{c} cos β - {z}_{c} sin β ) + {Q}_{Rx} \\ where \\ [ \begin{matrix}{f}_{y} \\ {f}_{z}\end{matrix} ] = [ \begin{matrix}cos β & sin β \\ - sin β & cos β\end{matrix} ] [ \begin{matrix}{F}_{Y} \\ {F}_{Z}\end{matrix} ] & ( 6 c )\end{matrix}$$

In (6), the magnetic forces f_{y} and f_{z} (in the rotor coordinate frame) and torque Tₓ are nonlinear functions of x, z, β; Iₓₓ is the moment of inertia of the rotor about the y-axis; and (x_{c}, y_{c}, z_{c}) is the coordinates of cₘ in the rotor frame. The magnetic forces and torque may be passive (if Mₛ is a PM assembly) or active (if Mₛ is an EM system).

To give insight to the effect of different designs on the maglev stability, the linear approximation for a perturbation study about an equilibrium x̅( y̅= β̅=0, z̅) where f̅_{y}= T̅ₓ=0, f̅_{z}=mg is derived. With the approximate force and torque functions,

$$[ \begin{matrix}{\hat{F}}_{y} \\ {\hat{F}}_{z} \\ {\hat{T}}_{x}\end{matrix} ] \approx [ \begin{matrix}{\hat{f}}_{y} \\ {\hat{f}}_{z} \\ {\hat{T}}_{x}\end{matrix} ] \approx [ \begin{matrix}\partial {f}_{y} / \partial y & \partial {f}_{y} / \partial z & \partial {f}_{y} / \partial β \\ \partial {f}_{z} / \partial y & \partial {f}_{z} / \partial z & \partial {f}_{z} / \partial β \\ \partial {T}_{x} / \partial y & \partial {T}_{x} / \partial z & \partial {T}_{x} / \partial β\end{matrix} ] {\vert}_{x = \overline{x}} [ \begin{matrix}\hat{y} \\ \hat{z} \\ \hat{β}\end{matrix} ] \qquad ( 7 )$$

the perturbed rotor dynamics is given by

$$\begin{matrix}{m}_{r} {y}^{\ddot{\hat{}}} - {a}_{11} \hat{y} + ( - {a}_{13} + {m}_{r} g ) \hat{β} = 0 & ( 8 a ) \\ {m}_{r} {z}^{\ddot{\hat{}}} - {a}_{22} \hat{z} = 0 & ( 8 b ) \\ {I}_{xx} {β}^{\ddot{\hat{}}} - ( {a}_{33} + {m}_{r} {gz}_{c} ) \hat{β} - {a}_{31} \hat{y} = - {m}_{r} {gy}_{c} \\ where \\ {a}_{11} = \frac{\partial {f}_{y}}{\partial y} {\vert}_{\overline{X }} ; \\ {a}_{13} = \frac{\partial {f}_{y}}{\partial β} {\vert}_{\overline{X }} ; \\ {a}_{31} = \frac{\partial {T}_{x}}{\partial y} {\vert}_{\overline{X }} ; \\ {a}_{33} = \frac{\partial {T}_{x}}{\partial β} {\vert}_{\overline{X }} ; \\ {a}_{22} = \frac{\partial {f}_{z}}{\partial z} {\vert}_{\overline{X }} . & ( 8 c )\end{matrix}$$

The eigenvalues for the y, β and z modes are given by (9a), (9b) and (9c) respectively,

$$\pm \frac{1}{\sqrt{2}} \sqrt{C - \sqrt{{C}^{2} + \frac{4}{{m}_{r} {I}_{xx}} [ \begin{matrix}( {a}_{13} {a}_{31} - {a}_{11} {a}_{33} ) - \\ {m}_{r} g ( {a}_{31} + {a}_{11} {z}_{c} )\end{matrix} ]}} \\ \pm \frac{1}{\sqrt{2}} \sqrt{C + \sqrt{{C}^{2} + \frac{4}{{m}_{r} {I}_{xx}} [ \begin{matrix}( {a}_{13} {a}_{31} - {a}_{11} {a}_{33} ) - \\ {m}_{r} g ( {a}_{31} + {a}_{11} {z}_{c} )\end{matrix} ]}} \\ and \\ \pm \sqrt{{a}_{22} / {m}_{r}} \qquad ( 9 a , b , c )$$

where C=a₁₁/mᵣ+(a₃₃+mᵣgz_{c})/Iₓₓ.

Equation (8) offers some insight into the maglev stability in the open loop sense:

1. The z motion is undamped.

2. The z motion is decoupled from the y and β motions. For the z motion to be neutrally stable,

a₂₂=(∂f_{z}/∂z)| _{x̅}<0 (10)

3. As shown in Equation (8a) and (8c), the y and β motions are coupled. To ease the conditions for the y and β motion stability, it is desired to have the mass center of the rotor well below the rotation center c.

4. To minimize the coupling between the y and β motions, it is desired that

a) a₃₁=(∂Tₓ/∂y)| _{x̅}→0 (11)

b) a₁₃=(∂f_{y}/∂β) _{x̅}≈mᵣg (12)

In addition, the position regulation of the maglev can be decoupled from the orientation control of the SWM,

if Rᵣ>>rᵣ and rₛ (as shown in FIG. 4) (13)

The trade-off is the size and motion range of the rotor.

### Design Simulation

The models derived above are effective tools for analyzing the effects of key design parameters on the magnetic forces and torque on the rotor, on the coupling between the maglev and the SWM, as well as on the open-loop stability of the maglev in the open loop sense.

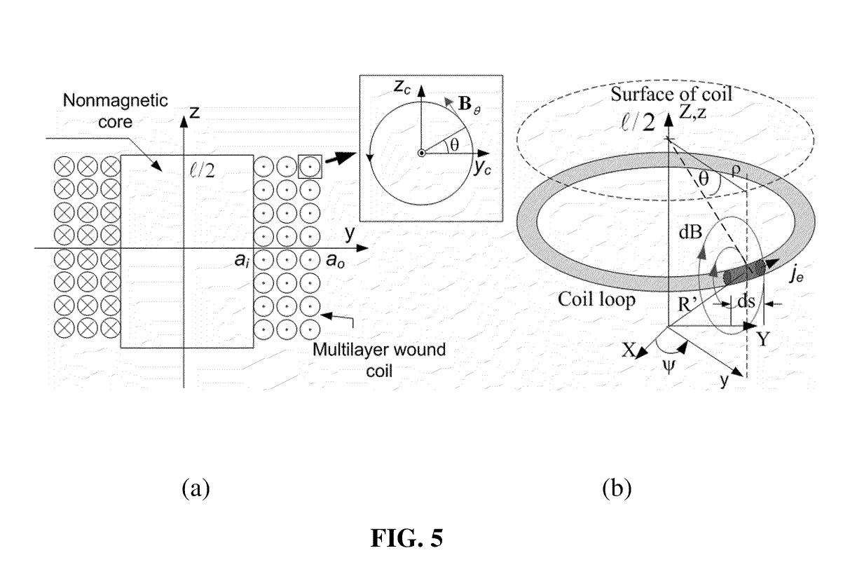

Since an EM can be modeled as a PM, the stator pole Mₛ is treated as a PM. An EM can be modeled as a PM, as shown in FIGS. 5a-5b, that illustrate the method of finding an equivalent single layer (ESL) model for an axi-symmetrical multilayer (ML) coil with a current density J. The axial (cumulative) magnetic flux within the core flows downward while that outside the coil flows upward. The switching radius aₑ where the flux reverses its direction can be found by minimizing the difference:

$${E}_{y} = {\int }_{0}^{∞} \vert {B}_{ML} ( y , z ) {• e}_{z} - {B}_{SL} ( y , z ) {• e}_{z} {\vert}_{z = 𝓁 / 2} d y \qquad ( 14 )$$

where B_{ML}(y, z) and B_{SL}(y, z) are the 2D magnetic flux density of the original ML and the ESL models respectively.

$$\begin{matrix}\frac{{B}_{Mz} ( y , 𝓁 / 2 )}{{μ}_{0} J 𝓁 / ( 2 π )} = \frac{1}{2} l n {[ ( \frac{1 + {χ}_{i -}^{2}}{1 + {χ}_{o -}^{2}} ) ( \frac{1 + {χ}_{i +}^{2}}{1 + {χ}_{o +}^{2}} ) ] +}_{{χ}_{i -} {ϑ}_{i -} - {χ}_{o -} {ϑ}_{o -} + {χ}_{i +} {ϑ}_{i +} - {χ}_{o +} {ϑ}_{o +}} & ( 15 ) \\ \frac{{B}_{Sz} ( y , 𝓁 / 2 )}{{μ}_{0} J 𝓁 / ( 2 π ) } = - \frac{{J}_{e} {d}_{w}}{J 𝓁} ( {cot}^{- 1} {χ}_{e -} + {cot}^{- 1} {χ}_{e +} ) & ( 16 )\end{matrix}$$

where χ_{±}=(a±y)/l; θ=cot⁻¹χ; and the subscripts i, o, and e denote inner, outer and effective radius respectively. The effective current density Jₑ is determined such that B_{ML}(0,±l/2)=B_{SL}(0,±l/2) or

$${J}_{e} {d}_{w} = \frac{J 𝓁}{{cot}^{- 1} ( {a}_{e} / 𝓁 )} [ {χ}_{o} {cot}^{- 1} {χ}_{o} - {χ}_{i} {cot}^{- 1} {χ}_{i} - \frac{1}{2} ln ( \frac{1 + {χ}_{i}^{2}}{1 + {χ}_{o}^{2}} ) ] \qquad ( 17 )$$

where χᵢ=aᵢ/l; χₒ=aₒ/l and χₑ=aₑ/l. The unknown parameters (aₑ and Jₑ) are solved simultaneously from (14) and (17). For an axi-symmetrical coil, a 2D model is sufficient for deriving the unknown parameters of the ESL model.

The ESL model reduces the computation time of the Lorentz force; however, the magnetic flux density must be integrated numerically from the Biot-Savart law in 3D space (FIG. 5b). For design optimization, it is desired to have the magnetic field solutions in closed form. This is achieved by modeling the coil as an equivalent PM with an effective radius, length and magnetization vector (aₑ, l, Mₑe_{z}). The effective magnetization vector is determined by satisfying

B_{PM}(0,0,l/2)□e_{z}=B_{ML}(0,0,l/2)□e_{z}.

For a cylindrical PM,

B_{PM}(0,0,l/2)□e_{z}=0.5μₒMₑ[1+(aₑ/l)²]^{-1/2} (18)

The effective Mₑ can then be obtained from (19):

μₒMₑ=2\sqrt{1+(aₑ/l)²}B(0,0,l/2)□e_{z} (19)

where B(0,0,l/2) is given by the Biot-Savart law.

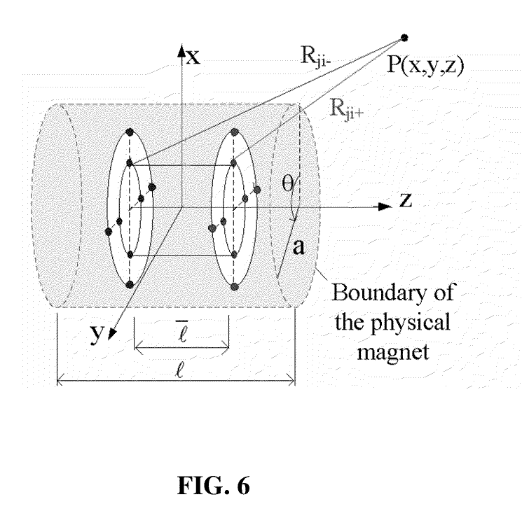

All the magnets are cylindrical neodymium magnets (N42), and have a unit aspect ratio 2a/l=1 where the dimensions are defined in FIG. 6. The PM is modeled using a DMP method, wherein one dipole is along the magnetization axis and a ring of six evenly spaced dipoles. The DMP parameters are summarized in Table 1, and the magnetic flux density of each PM can be computed as disclosed below.

TABLE 1

| | Rotor PMᵣ | Mₛ in Design A | Mᵢ in Design B |
|---|---|---|---|
| 2a × l (mm) | 25.4 × 25.4 | Same as | 12.7 × 12.7 |
| mₒ, m₁ | −0.0886, | PMᵣ | −0.0222 |
| (T/m² × 10⁻³) | 0.2396 | | 0.0599 |

g = 0.5 mm;
h = 31.16 mm;
Rᵣ = 17.96 mm;
μMₒ = 1.31T;
l̅/l = 0.5137
φₛ = 45°

### Distributed Multiple Pole (DMP) Model of a PM

We define a dipole here as a pair of source and sink separated by a distance l̅. FIG. 6 shows a DMP model of the cylindrical magnet (radius a, length l and M=Mₒe_{z}), where k circular loops (each with radius āⱼ) of n dipoles (0< l̅<l) are placed in parallel to the magnetization vector. For a cylindrical PM, the k loops are uniformly spaced:

āⱼ=aj/(k+1) at z=± l̅/2 where j=0, 1, . . . , k 20)

The method for finding an optimal set of parameters (k, n, δ, and mⱼ where j=0, . . . , k) can be found. Once the DMP model is found, its magnetic flux density in closed form can then be characterized by

$$B = - \frac{{μ}_{o}}{4 π} {\sum }_{j = 0}^{k} {\sum }_{i = 0}^{n} {m}_{ji} ( \frac{{a}_{Rji +}}{{R}_{ji +}^{2}} - \frac{{a}_{Rji -}}{{R}_{ji -}^{2}} ) \qquad ( 21 )$$

where mⱼᵢ is the strength of the ji^{th} dipole; Rⱼᵢ₊ and Rⱼᵢ₋ are the distances from the source and sink to P respectively. Expressed in terms of the distance l̅,

$$\begin{matrix}{R}_{ji \pm }^{2} = {[ x - {\overline{a}}_{j} cos i {θ}_{n} ]}^{2} + {[ y - {\overline{a}}_{j} sin i {θ}_{n} ]}^{2} + {( z ∓ \overline{𝓁} / 2 )}^{2} & 22 ) \\ \frac{{a}_{Rji \pm }}{{R}_{ji \pm }^{2}} = \frac{( x - {\overline{a}}_{j} cos i {θ}_{n} ) {a}_{x} + ( y - {\overline{a}}_{j} sin i {θ}_{n} ) {a}_{y} + ( z ∓ \overline{𝓁} / 2 ) {a}_{z}}{{[ {( x - {\overline{a}}_{j} cos i {θ}_{n} )}^{2} + {( y - {\overline{a}}_{j} sin i {θ}_{n} )}^{2} + {( z ∓ \overline{𝓁} / 2 )}^{2} ]}^{3 / 2}} & 23 )\end{matrix}$$

where iθₙ indicates the angular position of the i^{th} dipole on the j^{th} loop and θₙ=2π/n.

### Magnetic Forces/Torque as a Function of y, z and β

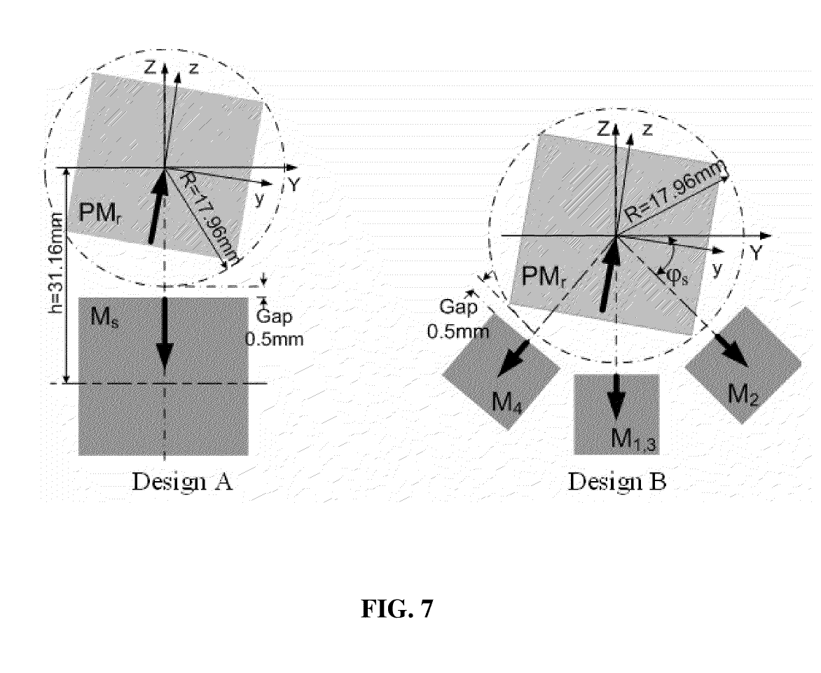

These effects of Mₛ are investigated by comparing the simulated magnetic forces and torque of two characteristic designs as shown in FIG. 7; both designs have the same volume of permanent magnets.

Design A has only one stator Mₛ to regulate the z motion of the rotor PMᵣ.

Design B uses multiple Mₛ (inclined at an angle φₛ from the Y axis as shown in FIG. 7), and is capable of regulating both y and z translational motions. The simulation here assumes four Mₛ symmetrically placed (at φₛ=45°) in the XZ and YZ planes.

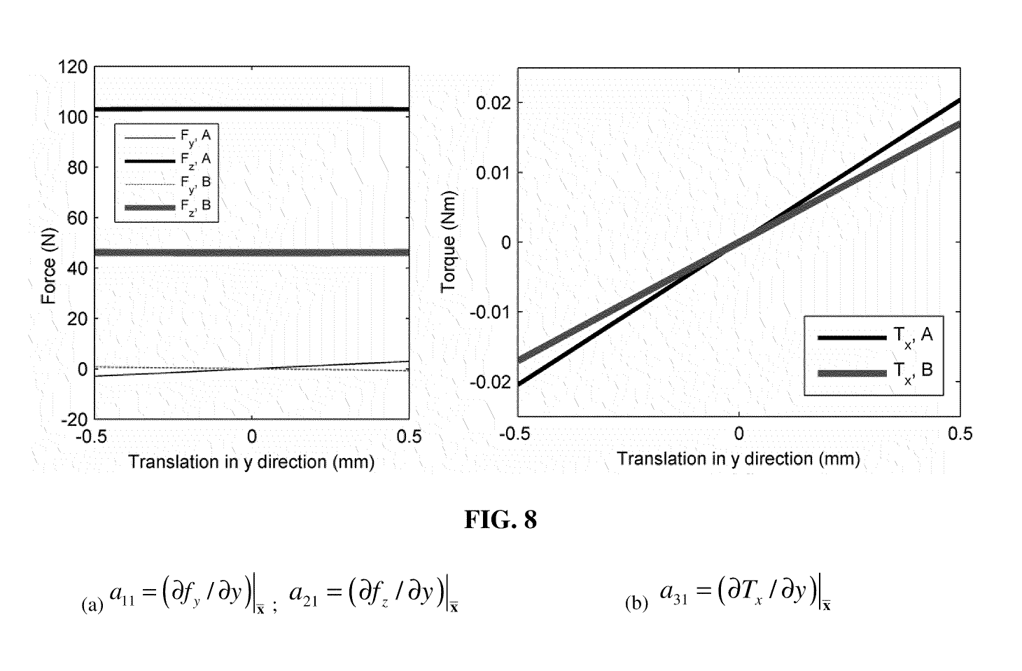

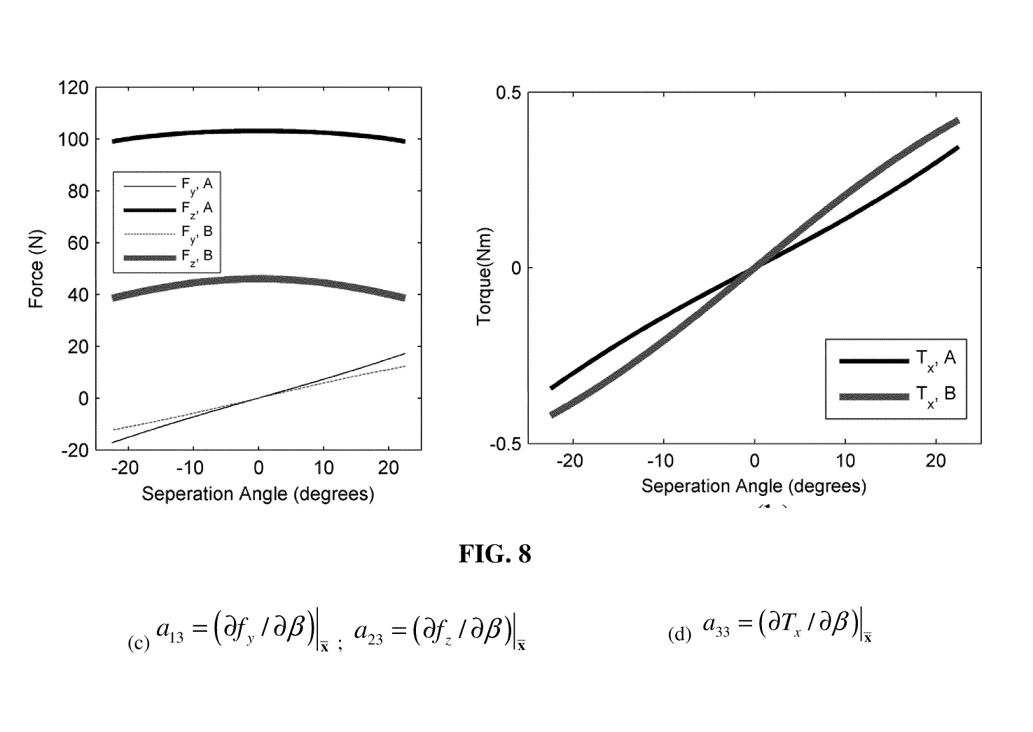

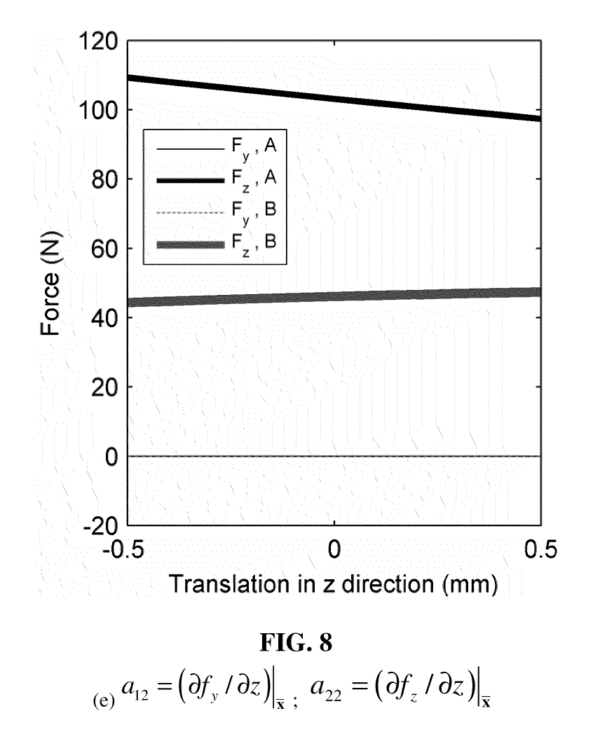

FIGS. 8a-8e summarizes the magnetic forces and torque (acting on the rotor) computed using (4a) and (4b). Once the forces and torque as a function of y, z and β are known, the coefficients of the linearization (a₁₁, a₁₃, a₂₂, a₃₁, and a₃₃) defined in (7) and (8) can be determined.

The coefficients of perturbation model are shown in Table 2.

TABLE 2

| | a₁₁ | a₁₃ | a₂₂ | a₃₁ | a₃₃ |
|---|---|---|---|---|---|
| | kN/m | N/rad | kN/m | Nm/m | Nm/rad |
| A | 6 | 43.79 | −11.88 | 40.8 | 0.88 |
| B | −1.44 | 31.2 | 3.07 | 34 | 1.07 |

Some observations from the results shown in FIGS. 8a-8e (where the thin and thick lines denote Designs A and B, respectively) are briefly discussed as follows:

The two designs have distinctly different a₂₂=(∂f_{z}/∂z)| _{x̅} indicated by thick lines in FIG. 8e, which is negative for Design A but slightly positive (and hence open-loop unstable z motion) for Design B.

The magnetic force f_{z}, however, is independent of y within the motion range of ±0.5 mm, and varies only less than 0.5% within the β range of ±22.5° as shown in FIGS. 8a and 8c respectively.

The two designs also differ in a₁₁=(∂f_{y}/∂y)| _{x̅}. As shown in thin lines in FIG. 8a, Design A has a positive a₁₁ that tends to destabilize the y motion, while a₁₁ is negative in Design B.

The effects of φₛ on f_{z}(x=0) and the stiffnesses are illustrated in Table 3. A design when both a₁₁ and a₂₂ are negative would result in low (∂f_{y}/∂y and ∂f_{z}/∂z) stiffness. Comparing between a₁₁ and a₂₂ in Table 3 shows that the angle φₛ represents a design trade-off between the y and z motions. This suggests that an optimal configuration is a combination of Designs A and B.

TABLE 3
Effect of inclination angle φₛ (Design B)

| | f_{z}(0) | a₁₁ | a₁₃ | a₂₂ | a₃₁ | a₃₃ |
|---|---|---|---|---|---|---|
| φₛ | N | kN/m | N/rad | kN/m | Nm/m | Nm/rad |
| 40° | 24.8 | −3.4 | 20 | 7 | 19 | 1.03 |
| 48.25° | 59.15 | −0.015 | 37 | −0.21 | 42.4 | 1.086 |
| 50° | 65.7 | 0.77 | 40.57 | −1.4 | 46 | 1.09 |
| 60° | 97 | 4.9 | 50.86 | −9.8 | 56 | 0.97 |
| 70° | 114.7 | 7.5 | 49.14 | −15 | 47 | 0.80 |

### Effects of Different Design on Open-Loop Stability

In order to gain some insight into the effects of different designs and the coupling term on the open-loop stability, the open loop stability is analyzed based on the model linearized about the equilibrium. As Design B has a smaller f̅_{z}=mᵣg than Design A, it is assumed that the additional magnetic force needed to keep the rotor at the same equilibrium is provided by the spherical motor.

Table 4 tabulates the eigenvalues of Designs A and B with two different φₛ values. The following conclusions can be drawn from Table 4:

Design A: Only the z motion is open loop naturally stable. The coupling (or the 3^{rd}) term that contains a gravitational component in (8a) has a stabilizing effect on both y and β motions. This can be explained with the aid of FIG. 7 as follows: When the rotor is displaced to the right, the misalignment causes it to rotate counter-clockwise. Without the coupling term in (8a), the y-mode eigenvalues would be ±24.5. Since mᵣg>a₁₃, the coupling term (that reduces the unstable pole from +24.5 to +23.7) has the tendency to restore the equilibrium. Similarly, the gravitational term in the second term in (8c) plays a similar role in the β motion stability.

Design B: When φₛ=45°, only the y motion is open loop naturally stable. In Design B(φₛ=48.25°) that represents a trade-off between the y and z motions, both the y and z motions are open loop naturally stable.

The β motion is unstable in all three configurations, and thus must be stabilized by the orientation control of the spherical motor.

TABLE 4
Simulation parameters and eigenvalues

Eigenvalues

| Design | y mode | z mode | β mode |
|---|---|---|---|
| A | ±23.71 | ±j34.47 | ±8.94 |
| B (45°) | −5.22 ± j8.27 | ±17.52 | 5.22 ± j8.27 |
| B (48.25°) | −9.32 ± j7.49 | ±j4.58 | 9.32 ± j7.49 |

mᵣ = 10 kg,
Iₓₓ = 0.0126 kg-m²,
f̅ₜ = 100 N,
y_{c} = 0,
z_{c} = −3 mm

### Maglev in Closed Loop Control of SWM

For a limited range of payload, it is theoretically possible to design a self-regulating maglev by combining Design A and Design B with appropriately positioned counterweight and optimally-selected φₛ. However, the effectiveness of such an open loop system is limited as any payload on the stage would raise the center of gravity and tend to destabilize the system. A more effective alternative is to utilize the control system of the SWM. A general method of controlling a six-DOF spherical motor is known. The focus here is to provide a means to predict the effect of the maglev design on the required magnetic forces and torque of the SWM, the actuation of which is provided by the pole-pairs formed by the stator EM and rotor PM as shown in FIG. 2.

As an illustration, a classical PD controller is considered, where the controlling input can be written as

Q=[Q_{y}Q_{z}Q_{Rx}]^{T}=[Kₚ]e+[K_{d}]ė (24)

where the state error vector e and its derivative can be determined with a set of field-based sensors and state estimator. Using (8) and (14), the SWM with the maglev Designs A and B in response to an initial deviation (0.5 mm and 10 mrad) can be simulated.

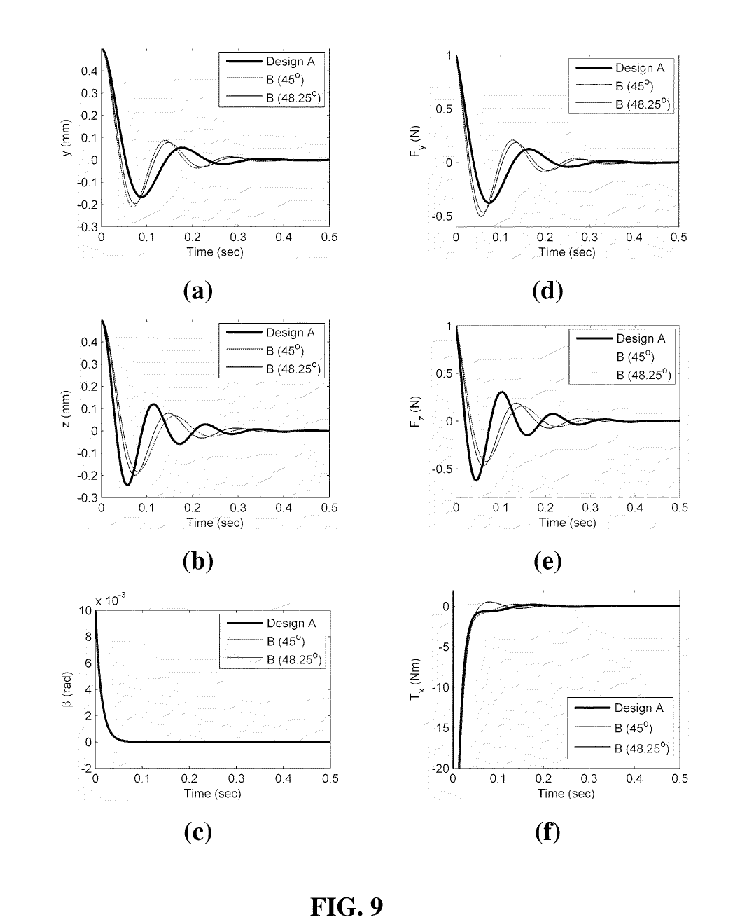

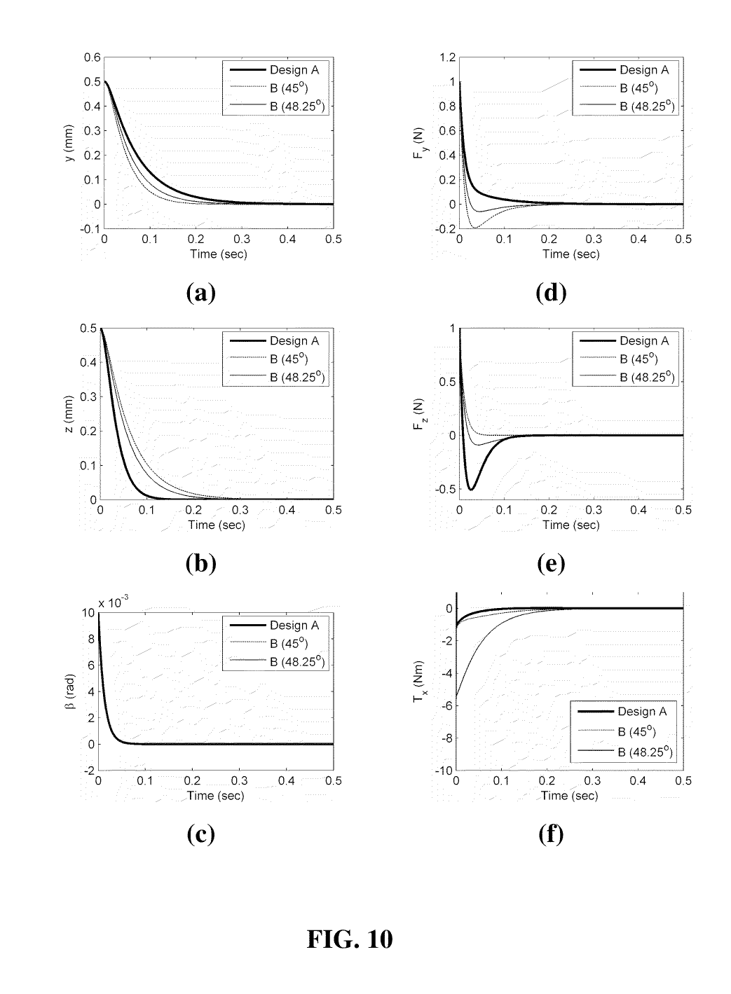

FIGS. 9a-9f compares the responses among the three design configurations with the following controller gains:

[Kₚ]=20,000[I]_{3×3} and [K_{d}]=250α[I]_{3×3}.

where an initial α=1 is selected for the convenience of illustration. Based on the simulated results, the derivative gain was then tuned to yield critical damped responses, for which a somewhat common α is found to be 4.52. The closed-loop poles for the three designs are tabulated in Table 5. The time responses for α=1 and α=4.52 are given in FIGS. 9a-9c and 10a-10c, respectively. The corresponding input forces and torque are plotted in FIGS. 9d-9f and 10d-10f.

TABLE 5
Effect of α on the closed-loop poles

| | Design A | Design B (45°) | Design B (48.25°) |
|---|---|---|---|
| α = 1 | −19761, −80, | −19761, −80, | −19761, −80, |
| | −12 ± j35, | −12 ± j45, | −12 ± j43, |
| | −13 ± j55 | −13 ± j39 | −13 ± j43 |
| α = 4.52 | −89665, −99, | −89665, −89, −24, | −89665, −91, −18, |
| | −14, −18, −59, | −18, −95, −18 | −22, −91, −22 |
| | −54 | | |

As compared in FIGS. 9 and 10, Design B exhibits a shorter rise time in the y response, but longer z-motion rise time than Design A. Similarly, Design B (48.25°) is slightly more responsive than Design B (45°) in the z-motion control. All three designs yield a nearly identical β-motion response as they have negligible influence on the orientation control.

The above results are somewhat expected, suggesting that an optimal maglev design is a combination of Design A and Design B, as the former has a much higher z-motion stiffness while the latter offers more effective translation motion on the x-y plane, leaving the orientation control to the SWM.

A method for design and control of a PM-based maglev bearing for a multi-DOF tiltable stage that inherits the isotropic motion properties of a ball-joint while allowing for contact-free manipulation is thus disclosed.

The design method has been demonstrated by comparing the two characteristic configurations. Key design parameters that significantly influence the maglev performance have been identified along with a detailed analysis investigating their effects on the open loop stability and on the dynamic performance a spherical wheel motor.

While the design method has been discussed in the context of passive control with permanent magnets, the fact that a multilayer electromagnet can be modeled as an equivalent permanent magnet suggests its applicability to a wide spectrum of maglev designs involving PM and/or EM.

The following are herein incorporated by reference in their entirety: Park, J. K., “Development of next generation microfactory systems”, 2^{nd} International workshop on Microfactory Technology, 2006 p. 6-7. Lee, K-M. and S. Arjunan, “A three-DOF micro-motion in-parallel actuated manipulator,” IEEE Trans. on Robotics and Automation, vol. 7, no. 5, 1991, p. 634-641. Shchokin, B., and F. Janabi-Sharifi, “Design and kinematic analysis of a rotary positioner”, Robotica, vol. 25, 2005. Ng, C. C., S. K. Ong, and A. Y. C. Nee, “Design and development of 3-DOF modular micro parallel kinematic manipulator”, International J. of Advanced Manufacturing Tech., vol. 31, 2006. Lee, K.-M., and C. Kwan, “Design concept development of a spherical stepper for robotic applications,” IEEE Trans. on Robotics and Automation, 7(1), 1991, p. 175-181. Vachtevanos, G., J. K. Davey and, and K. M. Lee, “Development of a novel intelligent robotic manipulator,” IEEE Control Systems Magazine, 7(3), 1987, p. 9-15. K. M. Lee, R. B. Roth, and Z. Zhou, “Dynamic modeling and control of a ball-joint-like variable-reluctance spherical motor,” ASME Journal of Dynamic Systems, Measurement, and Control, 118(1), 1996, p. 29-40. Wang, J., G. W. Jewell, and D. Howe, “A novel spherical actuator with three degrees-of-freedom,” In IEEE Transactions of Magnetics, vol. 34, 1998, p. 2078-2080. Chirikjian, G. S. and D. Stein, “Kinematic design and commutation of a spherical stepper motor,” IEEE/ASME Transactions on Mechatronics, 4(4), 1999, p. 342-353. Lee, K.-M. R. A. Sosseh and Z. Wei, “Effects of the Torque Model on the Control of a VR Spherical Motor,” IFAC Journal of Control Engineering Practice, 12(11), 2004, p. 1437-1449. Yan, L., I. M. Chen, G. L. Yang, and K. M. Lee, “Analytical and experimental investigation on the magnetic field and torque of a permanent magnet spherical actuator,” IEEE/ASME Transactions on Mechatronics, 11(4), 2006, p. 409-419. Purwanto E. and S. Toyama, “Development of an ultrasonic motor as a fine-orienting stage,” IEEE Transactions on Robotics and Automation, 17(4), 2001, p. 464-471. Hollis, R. L., Salcudean S. E., & Allan, A. P., “A Six-Degree-of-Freedom Magnetically Levitated Variable Compliance Fin-Motion Wrist: Design, Modeling, and Control,” IEEE Transactions on Robotics and Automation, vol. 7, no. 3, 1991, p. 320-332. Zhou, Z. and K-M. Lee, “Real-Time Motion Control of a Multi-Degree-of-Freedom Variable Reluctance Spherical Motor,” Proc. of the 1996 IEEE ICRA, Minneapolis, Minn., vol. 3, 1996, p. 2859-2864. Lee, K. M., D. E. Ezenekwe, and T. He, “Design and control of a spherical air-bearing system for multi-DOF ball-joint-like actuators,” Mechatronics, 13 (2003), 2003, p. 175-194 Son, H. and K.-M., Lee, “Distributed Multi-Pole Model for Motion Simulation of PM-based Spherical Motors,” IEEE/ASME AIM2007, ETH Zurich, Switzerland, 2007. Lee, K.-M. and H. Son, “Equivalent Voice-coil Models for Real-time Computation in Electromagnetic Actuation and Sensor Applications,” IEEE/ASME AIM2007, ETH Zurich, Switzerland, 2007. Lee, K.-M. and H. Son, “Torque model for design and control of a spherical wheel motor,” IEEE/ASME AIM2005 Proc., 2005, p. 335-340. Lee, K.-M. and H. Son, “Design of a Magnetic Field-Based Multi Degree-of-freedom Orientation Sensor using the Distributed-Multiple-Pole Model,” ASME IMECE2007, Seattle, Wash., USA, 2007. Son, H. and K.-M., Lee, “Design of Controllers for a multi-degree-of-freedom spherical wheel motor,”. ASME IMECE2007, Seattle, Wash., USA, 2007. Lee, K.-M., H. Son, and J.-L. Park, Design Analysis OF A Spherical Magnetic Bearing for Multi-DOF Rotational Stage Applications Proc. MSEC2007, Atlanta, USA, 2007.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

We claim:

1. A multi-DOF system comprising:
a bearing for centering a first body relative a second body; and
a work piece surface tiltable via the first body;
wherein the bearing comprises a magnetically levitated bearing.

2. The multi-DOF system of claim 1, wherein the first body comprises a rotor.

3. The multi-DOF system of claim 1, wherein the first body comprises a spherical rotor having a plurality of rotor magnetic field generators.

4. The multi-DOF system of claim 3, wherein the plurality of rotor magnetic field generators comprise permanent magnets.

5. The multi-DOF system of claim 1, wherein the second body comprises a stator.

6. The multi-DOF system of claim 1, wherein the second body comprises a spherical stator having a plurality of stator magnetic field generators.

7. The multi-DOF system of claim 6, wherein the plurality of stator magnetic field generators comprise electromagnets.

8. A multi-DOF system comprising:
a spherical rotor having a plurality of rotor magnetic field generators;
a spherical stator having a plurality of stator magnetic field generators;
a bearing for centering the rotor relative the stator; and
a work piece surface tiltable via the rotor;
wherein the bearing comprises a magnetically levitated bearing.

9. The multi-DOF system of claim 8, wherein the rotor has a center of rotation, and the plurality of rotor magnetic field generators comprises a primary rotor permanent magnet, and at least one ring of permanent magnets with their axis pointing towards the center of rotation.

10. The multi-DOF system of claim 8, wherein the spherical rotor is concentric with the stator, and has an infinite number of rotational axes about its center.
